(19) United States
(12) Patent Application Publication
(10) Pub. No.: US 2026/0285736 A1
(43) Pub. Date: Sep. 24, 2026

(54) METHOD FOR DETERMINING A BATCH BLANKET TOP SURFACE LEVEL AT A COLD TOP ELECTRIC GLASS FURNACE

(71) Applicant: GLASS SERVICE, a.s., Vsetin (CZ)

(72) Inventors: Jan BENSCH, Halenkov (CZ); Petr JANDÁCEK, Vsetin (CZ); Josef MÜLLER, Olomouc (CZ)

(21) Appl. No.: 19/477,151

(22) PCT Filed: Apr. 21, 2023
(86) PCT No.: PCT/EP2023/060449

§ 371 Date: Oct. 21, 2025

(51) Int. Cl. C03B 5/24; G01B 17/02; G01F 23/284

(52) U.S. Cl. CPC C03B 5/245; G01B 17/02; G01F 23/284

(57) ABSTRACT

The invention is directed to a method (500) for determining a batch blanket top surface level (2.1) at a cold top electric glass furnace (50), the method comprising the steps of: -providing (502) a measurement setting (40), -determining (504), during a predetermined measure-window time span (W), distance values indicative of a distance (d) between the measuring position (20) and the batch blanket top surface (18); -determining a characteristic distance value (MV) indicative of a central tendency of the distance values (d) determined during at least a fraction of the measure-window time span (W); -providing the characteristic distance value (MV) as a batch blanket top surface level (2.1).

### CROSS REFERENCE TO RELATED APPLICATIONS

This application is a U.S. National Phase application under 35 U.S.C. § 371 of International Application No. PCT/EP2023/060449, filed on Apr. 21, 2023. The International Application was published in English on Oct. 24, 2024 as WO 2024/217697 A1 under PCT Article 21(2).

### FIELD

The present invention is directed to a method for determining a batch blanket top surface level at a cold top electric glass furnace, a method for determining a batch blanket thickness amount, a method for controlling operation of a cold top electric glass furnace, a cold top electric glass furnace, and a computer program.

### BACKGROUND

U.S. Pat. No. 4,262,158 discloses a hydraulic head of a cold top electric furnace for melting of batch, such as glass batch, employing an electric resistance heater, which is electrically controlled by sensed temperature. The temperature is measured below the batch layer or crust, often referred to as batch blanket, at the area of interface transition from the solid material to the liquid melted state. A second sensor is placed within the furnace liner below and adjacent the screen heater within the molten material. The temperature signals at either of the locations are related to the hydraulic head within the furnace. The head is controlled responsive to these temperature signals by either adding additional material or diminishing the amount of material being added to the furnace.

U.S. Pat. No. 6,712,576 B2 discloses an apparatus for delivering and distributing powdered materials over a surface for charging a cold top furnace for the production of molten glass.

It would be beneficial to enable the accurate determination of furnace parameters that are used in a control process of a cold top furnace.

### SUMMARY

In an embodiment, the present disclosure provides a method for determining a batch blanket top surface level at a cold top electric glass furnace, the method comprising providing a measurement setting having a measuring position in relation to a surface of measurement. The measuring position is assigned to a predetermined reference point of the cold top electric glass furnace and the surface of measurement is assigned to a batch blanket top surface situated in the cold top electric glass furnace on a glass melt. The batch blanket top surface level is subject to level variations. The method further comprises determining, during a predetermined measure-window time span, distance values indicative of a distance between the measuring position and the batch blanket top surface, determining a characteristic distance value indicative of a central tendency of the distance values determined during at least a fraction of the measure-window time span, and providing the characteristic distance value as a batch blanket top surface level.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic cross sectional representation of a cold top electric glass furnace;

FIG. 2 illustrates a schematic view of an empty and open cold top electric glass furnace of a hexagonal shape;

FIG. 3A illustrates a schematic top view of the cold top electric glass furnace of FIG. 2 with a movable batch feeding device, shown in three different positions and an examplifying trajectory of the distal end of the batch feeding device;

FIG. 3B illustrates a representation of a batch blanket covering melted glass in the cold top electric glass furnace of FIG. 2 and FIG. 3A, which is covered by a crown to avoid heat losses;

FIG. 4 illustrates a scheme of a measuring setting;

FIG. 5 illustrates a flow diagram of an embodiment of a method for determining a batch blanket top surface level at a cold top electric glass furnace as shown in FIG. 1 to FIG. 4;

FIG. 6A illustrates the representation of the cold top electric glass furnace of FIG. 3A and with the position of the measurement orifice;

FIG. 6B illustrates a time diagram including distance values determined at a predetermined sampling frequency during a measure-window time span of some seconds for one full period of a batch charger wherein the data are shown as raw data and median filtered data;

FIG. 7 illustrates a time diagram showing a comparison of the median-filtered data of ten subsequent subperiods;

FIG. 8 illustrates a schematic simplified cross sectional view of a cold top electric glass furnace in accordance with an embodiment of the present disclosure; and

FIG. 9 illustrates a flow diagram of an embodiment of a method for determining a batch blanket thickness amount.

### DETAILED DESCRIPTION

In an embodiment, the present disclosure provides an improved, preferably contactless, method and device for determining a batch blanket top surface level and/or batch blanket thickness amount.

The method is directed to determining a batch blanket top surface level at a cold top electric glass furnace. The method comprises the steps of:
providing a measurement setting having a measuring position in relation to a surface of measurement, wherein the measuring position is assigned to a predetermined fixed reference point of the cold top electric glass furnace and the surface of measurement is assigned to a batch blanket top surface situated in the cold top electric glass furnace on a glass melt, wherein the batch blanket top surface level is subject to level variations;
determining during a predetermined measure-window time span distance values indicative of a distance between the measuring position and the batch blanket top surface during a predetermined measure-window time span;
determining a characteristic distance value indicative of a central tendency of the distance values determined during the measure-window time span; and
providing the characteristic distance value as a batch blanket top surface level.

Typically, the variations of the batch blanket top surface are at least due a melting of the batch into the glass melt below the batch blanket bottom surface, feeding of batch material on top of the batch blanket top surface and pull of glass out of the glass melt.

The measuring position is assigned to the predetermined reference point of the cold top electric glass furnace, which preferably should be chosen typically at a fixed position.

The predetermined reference point preferably provides a position at least with respect to a plane that is substantially parallel to the batch blanket level top surface.

The batch blanket level top surface can adopt different patterns. Preferably, and apart from localized variations produced by a non-homogeneous (at least on a small scale) feeding of batch material, the batch blanket level top surface adopts a regular and uniform pattern all across the surface. However, a so-called hot ring can appear, caused by the heavy batch material pushing down the molten glass and going up around the furnace walls, creating a hot ring outside and cold batch in the middle of the furnace. The batch blanket level top surface can also adopt an irregular pattern, which is the least preferred condition, sometimes indicative of a quick crown temperature rise.

The distance value, which is indicative of a distance between the measuring position and the batch blanket top surface, is determined during a predetermined measure-window time span, which is preferably a significant part of a batch load cycle, for example 100% of the batch load cycle, 50% of the batch load cycle, 25% of the batch load cycle or 10% of the batch load cycle.

The distance values determined are then used to determine the characteristic distance value indicative of a central tendency of the distance values determined during the measure-window time span at the measuring position. The characteristic distance value is thus indicative of a central tendency, such as a mean value, a median value, a mode value or any other statistical parameter that is indicative of a central tendency of a set of values.

Thus, the method of the first aspect of the present disclosure enables the determination of a batch blanket top surface level with increased accuracy, which is an important parameter for controlling operation of a cold top furnace.

In the following, developments of the method of a first aspect of the present disclosure will be described.

In an embodiment, the distance values are determined at a predetermined measuring frequency, i.e. a sampling frequency, and wherein the respective characteristic distance values are preferably determined and provided using those distance values determined during a floating measurement window.

Thus, in a so-called steady state where the measurements have been carried out for a time span that is longer than that of the floating measurement window, each measurement of the distance value updates the characteristic distance value determined, which is then also preferably provided at the same measuring frequency at which the distance values are determined.

In an embodiment, the predetermined reference point is a fixed position. The fixed position is preferably arranged at a crown of the glass furnace.

In an embodiment, the characteristic distance value is a statistical value indicative of a mean value, a median value or a mode value of the distance values determined during the at least a fraction of the predetermined measure-window time span.

The characteristic distance value preferably is a weighted or non-weighted average value determined from measured distance values. In a particular embodiment, a set of first central tendency values is determined, for instance a median value of a set of values obtained during a moving time window, e.g. a 10 point median value, a 20 point median value, a 30 point median value, etc., for reducing the impact of outlying distance values, that do not represent the actual distance and that can be caused by a batch feeding device blocking the line of sight of a distance-measuring apparatus. Then, the characteristic distance value is determined using the set of first central tendency values for determination of a second central tendency, which can or can not be the same central tendency as the first central tendency. In other words, the first central tendency can be a 30 point median value and the second central tendency can be the same or different (e.g. a mean value, a 20 point median value or a 30 point median value of the set of first central tendency values).

Preferably, the characteristic distance value is determined using the distance values measured during the measure-window time span, which can span the whole batch load cycle duration or any fraction thereof. A filtering process for eliminating distance value measurements that could be considered as outliers using a given rule, can be applied in order to provide a more accurate characteristic distance value, such as, for instance a 30 point median value as explained above.

Particular dynamics in the time behaviour of the distance values have been identified. Thus, in a particular development, the method further comprises determining a plateau-time region in which the determined distance values form a graph with a gradient below a predetermined threshold value and wherein the determination of the characteristic distance value is performed using the distance values within the plateau-time region. The plateau-time region is thus a region of time in which the distance values determined are substantially constant or increase, due to the melting of the batch material, with a rate lower than a predetermined value, such as, for example, 0.05 mm/s, preferably lower than 0.01 mm/s.

In an embodiment, the method further comprises determining a surface drop value indicative of an overall variation, in particular an overall decrease of the batch blanket top surface level within a batch-load cycle. Thus, the surface drop value is the difference between an initial distance value indicative of the distance value when batch material has been deposited on the surface of measurement, i.e. that region or point of the batch blanket surface at which the distance to the measuring position is evaluated, and a final distance value indicative of the distance value when batch material is about to be deposited again on the surface of measurement, i.e., after a batch-load or batch-feed cycle. This value is indicative of the melting rate of the batch material and its knowledge is also beneficial for improving a control process of the cold top furnace.

In an embodiment, the method is suitable for increasing the spatial resolution of the results. In an embodiment, the method comprises:
providing the measurement setting having a plurality of measuring position in relation to the surface of measurement;
determining respective distance values indicative of a respective distance between the respective measuring position and the batch blanket top surface, i.e. respective points of the batch blanket top surface each associated to a respective one of the measuring positions, during a predetermined measure-window time span;
determining a respective characteristic distance value indicative of a central tendency of the respective distance values determined during the measure-window time span at the measuring position; and
providing the respective characteristic distance value as a mapping of the batch blanket top surface level.

According to a second aspect of the present disclosure, the method is directed to determining a batch blanket thickness amount. The thickness of a batch blanket, for a given thickness determination location, is defined as the distance between the batch blanket top surface and the interface between the solid batch blanket and the melted glass, typically along a vertical axis at the thickness determination location.

The method in accordance with the second aspect comprises:
ascertaining a glass-batch blanket interface value indicative of a position of a lower surface of the batch blanket, i.e. of the interface between the solid material (batch blanket) and the liquid melted state (melted glass) at one or more thickness determination locations;
performing the method of the first aspect of the present disclosure for determining the batch blanket top surface level; and
determining the batch blanket thickness amount using the ascertained glass-batch blanket interface value and the determined batch blanket top surface level.

The method for determining a batch blanket thickness amount of the second aspect of the present disclosure thus shares the advantages of the method for determining a batch blanket top surface level of the first aspect.

In the following, embodiments of the method of the second aspect will be described.

In an embodiment, the step of ascertaining the glass-batch blanket interface value comprises ascertaining a calibration value, in particular an electrode measurement value. For example, the glass-batch blanket interface value is determined by inserting one or more probes, typically metal rods, in the blanket and lowering their position until a change in an electrical parameter is detected, due to the fact that the melt is conductive.

In an embodiment, the step of ascertaining the glass-batch blanket interface value additionally or alternatively comprises determining a working end value of a glass level at a glass melt output, i.e. a furnace output of the cold top electric glass furnace. Typically, in cold top electric glass furnaces the melted glass exits the furnace via a furnace output that is connected to a main heating chamber via a syphon. The main heating chamber, or melting tank, is the chamber where the batch material is fed and heated to form the melted glass. The working end value of the glass level is in some instances also referred to as riser end value or refiner end value. The working end value is considered to embrace at least a level or height of the melted glass at the output. Said working end value, in well-designed cold top furnace, is substantially proportional to the height of the melted glass in the main heating chamber, i.e. the glass-batch blanket interface value.

According to a third aspect of the present disclosure, a method for controlling operation of a cold top electric glass furnace is provided.

The method for controlling operation of a cold top electric glass furnace according to the third aspect comprises:
performing the method of the first aspect of the present disclosure for determining a batch blanket top surface level and/or the method of the second aspect of the present disclosure for determining a batch blanket thickness amount;
controlling a power supply of the cold top electric glass furnace and/or a cullet supply amount and/or one or more batch parameter, in particulars in dependence on the batch blanket top surface level for maintaining the batch blanket top surface level within a predetermined operation range.

The method of the third aspect of the present disclosure thus shares the advantages of the method of the first aspect.

In an embodiment, the method of the third aspect further comprises:
performing the method of the second aspect of the present disclosure for determining a batch blanket thickness amount and/or the method of the second aspect of the present disclosure for determining a batch blanket thickness amount; and
controlling the power supply of the cold top electric glass furnace and/or the cullet supply amount and/or one or more batch parameter in dependence on the batch blanket thickness, for maintaining the batch blanket thickness within a predetermined operation range.

In particular, the power supply and/or the cullet supply amount and/or the one or more batch parameter, which can include for instance the humidity or the composition of the batch material constituents, are controlled so that the determined batch blanket thickness is maintained within a predetermined ranges, preferably a predetermined range of between 10 cm and 50 cm, more preferably between 20 cm and 30 cm. The preferred thickness of the batch blanket depends on the geometry of the cold-top furnace and the relative distance between the batch blanket and the batch feeding device or batch feeder.

If the batch blanket thickness is too small, then the hot glass can overheat the batch feeding device, thereby either damaging it or, if the furnace is equipped with temperature sensors, causing an emergency stop. If, on the other hand, the batch blanket thickness is too thick, then the batch feeding device can be too close to the blanket top surface, which can also cause an emergency stop. Thus, the accurate knowledge of the blanket top surface level and/or of the batch blanket thickness amount enables a targeted control of the cold top glass furnace for avoiding situations that can lead to damage of the furnace or to an emergency stop, both of these being associated with an undesirable cost increase.

According to a fourth aspect of the present disclosure, a cold top electric glass furnace is described. The cold top electric glass furnace, also referred to as the furnace, comprises:
a melting tank or the like heating chamber comprising a heating unit for heating a glass melt;
a batch feeder configured to provide batch material at predetermined different positions of the melting tank;
an output, in particular a syphon shaped output, comprising a throat section at a lower section of the melting tank, and a riser section connected to the throat section and extending upwards from the throat section to a glass melt output;
a crown arranged and configured to cover the melting tank, where at least one measuring position can be alternatively associated with at least one spot below the crown in general fixed position enabling a view of the batch blanket.

The cold top electric glass furnace also comprises a measurement setting having a measuring position in relation to a surface of measurement, wherein the measuring position is assigned to a predetermined reference point of the cold top electric glass furnace and the surface of measurement is assigned to batch blanket top surface situated in the cold top electric glass furnace on a glass melt, wherein the batch blanket top surface level is subject to level variations. The cold top electric glass furnace also comprises a contactless distance-determination unit. The contactless distance-determination unit is arranged at the measuring position and configured to provide a transmission radiation to the batch blanket top surface, to receive reflected radiation reflected by the batch blanket top surface, and to determine a distance amount between the measuring position and a reflection point at the batch blanket top surface.

The cold top electric glass furnace of the fourth aspect of the present disclosure further includes a control unit connected to the contactless distance-determination unit and configured to perform the method of the first aspect of the present disclosure for determining a batch blanket top surface level, and/or the method of the second aspect of the present disclosure for determining a batch blanket thickness amount, and/or the method of the third aspect of the present disclosure for controlling operation of a cold top electric glass furnace.

In the following, embodiments of the cold top electric glass furnace of the fourth aspect of the present disclosure will be described.

In an embodiment, the contactless distance-determination unit comprises an electromagnetic unit, such as an optical unit, in particular a laser unit or a radar unit, for providing electromagnetic radiation as the transmission radiation.

In an embodiment, the contactless distance-determination unit additionally or alternatively comprises an acoustic unit, in particular an ultrasound unit, for providing acoustic radiation, in particular ultrasonic radiation, as the transmission radiation.

In an embodiment, wherein the control unit is preferably configured to perform a method in accordance with the third aspect of the present disclosure for controlling operation of the cold top electric glass furnace, the cold top electric glass furnace also comprises one or more probes, typically metal rods, that are configured to be inserted in the batch blanket by lowering their position for determining the glass-batch blanket interface value. This is for instance done by monitoring the value of an electrical parameter that changes with the conductivity of the material surrounding the probes, as a function of the position, in particular the vertical position of the probe.

A fifth aspect of the present disclosure is formed by the computer program product comprising instruction which, when the program is executed by a control unit of a cold top electric glass furnace, for instance a cold top electric glass furnace in accordance with the fourth aspect, cause the control unit to carry out steps of any of the methods of the first aspect and/or the second aspect and/or the third aspect of the present disclosure.

These and other aspects of the present disclosure will be apparent from and elucidated with reference to the embodiments described hereinafter. The embodiments of the present disclosure are described in the following on the basis of the drawings in comparison with the state of the art, which is also partly illustrated. The latter is not necessarily intended to represent the embodiments to scale. Drawings are, where useful for explanation, shown in schematized and/or slightly distorted form. With regard to additions to the lessons immediately recognizable from the drawings, reference is made to the relevant state of the art. It should be borne in mind that numerous modifications and changes can be made to the form and detail of an embodiment without deviating from the general idea of the present disclosure. The features of the present disclosure disclosed in the description and in the drawings can provide for the further development of the present disclosure, either individually or in any combination.

In addition, all combinations of at least two of the features disclosed in the description and/or drawings fall within the scope of the present disclosure. The general idea of the present disclosure is not limited to the exact form or detail of the preferred embodiment shown and described below. For specified design ranges, values within the specified limits are also disclosed as limit values and thus arbitrarily applicable.

Further advantages, features and details of the present disclosure result from the following description of the preferred embodiments as well as from the drawings.

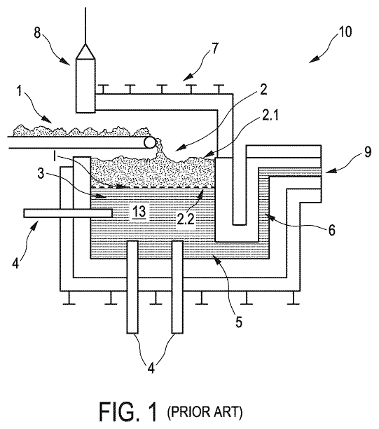

FIG. 1 shows a schematic cross sectional representation of a cold top electric glass furnace 10 as an example.

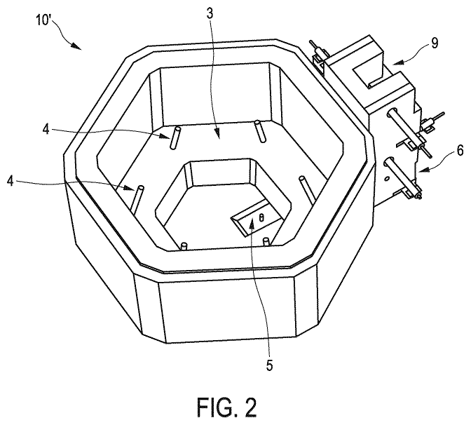

FIG. 2 shows a schematic view of an empty and open cold top electric glass furnace 10′ of a hexagonal shape, for example of approximately 40 m². The cold top electric glass furnaces 10 and 10′ comprise a main heating chamber 3, also referred to as melting tank.

Batch material is fed using a batch feeding device 1, typically a conveyor belt, preferably movable so that batch material can be controllably fed at different positions of the main heating chamber 3 to increase the homogeneity of the distribution of batch material that forms the batch blanket 2. The cold top electric glass furnace 10 comprises a plurality of electrodes 4 for heating the material inside the melting tank 3. The melted glass 13 is kept in a liquid state by the heat provided by the electrodes 4. The batch material in the batch blanket 2 that has been added on top of the melted glass 13 acts as an insulation layer. The batch blanket 2 position within the heating chamber 3 is characterised by a top surface level 2.1 and a lower surface level 2.2. The lower surface level 2.2 is located at the interface (I) with the melted glass 13. The batch material in the immediate vicinity of the melted glass gets melted due to the temperature of the melted glass 13. The cold top electric glass furnaces 10, 10′ has a syphon-shaped structure. Melted glass exits the melting tank 3 via a throat 5 located at, or close to, the bottom of the melting tank 3. The throat 5, which runs substantially horizontally, is connected to a riser section 6, which runs substantially perpendicular to the throat 5 and which ends in an outlet 9 from where the melted glass is extracted. To further avoid heat losses, the cold top electric glass furnace 10 also comprises a crown 7, and optionally a closing 8, for closing the heating chamber 3 when the batch feeding device, or batch feeder 1 is removed.

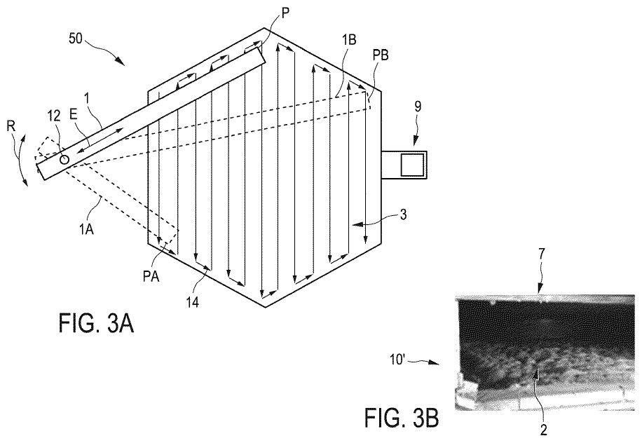

FIG. 3A shows a schematic top view of the cold top electric glass furnace 50′ with a movable batch feeding device 1, shown in three different positions, labelled as 1, 1A, and labelled as 1B in FIG. 3A.

The batch feeding device is extendable and retractable, as shown by the double arrow E, meaning that its effective length can be varied. Additionally, the batch feeding device 1 can be rotated, in this example around a pivoting point 12, as shown by the double arrow R. A combination of the extension/retraction and the rotation capabilities of the batch feeding device 1, enables the feeding device 1 to feed batch material to essentially every point on the heating chamber 3. An exemplary trajectory of the distal end of the batch feeding device 1 is shown in FIG. 3A indicated by the reference number 14. FIG. 3A also shows the batch feeding device in three different positions as a results of corresponding combinations of lengths and angles of the batch feeding device 1. The position of the batch feeding device 1 enables the delivery of batch material to position P. The position of the batch feeding device 1A enables the delivery of batch material to position PA. Analogously, the position of the batch feeding device 1B enables the delivery of batch material to position PB.

FIG. 3B shows a representation of a batch blanket 2 covering melted glass in the cold top electric glass furnace 10′, which is covered by a crown 7 to avoid heat losses. As it can be seen in FIG. 3B, the top surface of the batch blanket is irregular and shows a hilly structure. Each of the individual hills is the result of the batch feeding device depositing batch material at that particular location. After deposition, the batch material can re-arrange due to gravity and other factors.

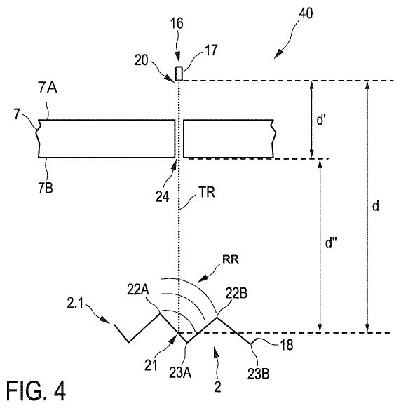

FIG. 4 shows a schematic representation of a measuring setting 40 where a contactless distance determination unit 16 is provided for determining a distance amount to the batch blanket top surface 18, i.e., the batch blanket top surface level 2.1, of the batch blanket 2. The measurement setting 40 is shown, which has a measuring position 20 that is in relation to a surface of measurement 18, in this case the batch blanket top surface. The measuring position 20 is assigned to a predetermined reference point of the cold top electric glass furnace. The predetermined reference point can be a fixed position, in particular a fixed position, preferably at a crown 7 of the glass furnace 10′, i.e., its position is fixed with respect to the cold top electric glass furnace, in this particular case with respect to the crown 7 of the cold top electric glass furnace 10′. For instance, in FIG. 4, the measuring position 20 of the measuring setting 40 is at a fixed distance d′ from the inner surface 7B of the crown 7, which is in turn at a variable distance d″ from the batch blanket top surface 18. The surface of measurement, whose position can vary with respect to the fixed measuring position 20, is assigned to batch blanket top surface 18 situated in the cold top electric glass furnace on a glass melt 13. The level of the batch blanket top surface 18 is subject to level variations. These level variations can be level differences between two different points, i.e. spatial variations and/or level differences at a single point determined at different times, i.e. time variations. One cause is the melting of the material of the batch blanket 2 into the glass melt below the batch blanket bottom surface. Since both materials i.e. batch blanket and melted glass, have different structural properties, the volume of the batch blanket 2, and therefore the distance with respect to a fixed measuring position 20 of the batch blanket surface 18 will vary. Another cause for the variation of the level of the batch blanket top surface is the pull of melted glass out of the glass melt via the outlet (see FIG. 1 and FIG. 2). This mechanism does not significantly affect the volume or thickness of the batch blanket 2, but increases the distance between the measuring position 20 and the batch blanket top surface 18. Finally, feeding of batch material on top of the batch blanket top surface 18 also causes a level variation which is particularly significant.

As explained with reference to FIG. 3A, the batch feeding device 1 feeds material at a plurality of points on the batch blanket surface 18. Hills 22A, 22B are formed at those locations where batch material is deposited and valleys 23A, 23B are formed at the locations between hills 22A, 22B. Every time batch material is deposited, the thickness of the batch blanket in general, and the shape of the top surface 18 of the batch blanket 2 in particular, varies. Also, mass wasting, or mass movement of the batch material caused by the force of gravity can transport batch material from a hill to a valley, thus varying the level of the batch blanket at the location of said mass movement.

The measurement setting 40 is configured to determine a distance value indicative of a distance d between the measuring position 20 and the batch blanket top surface 18, in particular a sampling point 21 at the batch blanket top surface, that preferably lies on a vertical line that extends from the measuring position 20. In order to protect the contactless distance determination unit 16 from the heat inside the main heating chamber 3, the contactless distance determination unit 16 is preferably arranged on an outer side 7A of the crown 7, which is opposite to an inner side 7B of the crown, which faces the main heating chamber.

In order to allow the contactless determination of the distance value indicative of the distance d, the crown comprises a measurement orifice 24 as a through hole or bore that is arranged and positioned to allow the transmission radiation TR (e.g. electromagnetic radiation or acoustic radiation) provided by the contactless distance determination unit 16 to reach the sampling point 21 at the batch blanket top surface 18 and to detect reflected radiation RR reflected by the batch blanket top surface 18 in order to determine the value of the distance d. In particular, the contactless distance-determination unit 16 comprises an electromagnetic unit 17, in particular an optical unit such as a laser unit, or alternatively a radar unit, for providing electromagnetic radiation as the transmission radiation, and to determine the distance amount d between the measuring position 20 and a reflection or sampling point 21 at the batch blanket top surface 18. Preferably, the through hole or orifice 24 is arranged at a central or close to a central position of the crown 7. Alternatively, or additionally, the determination unit can also comprise an acoustic unit, for providing acoustic waves as the transmission radiation for the determination of the distance value d.

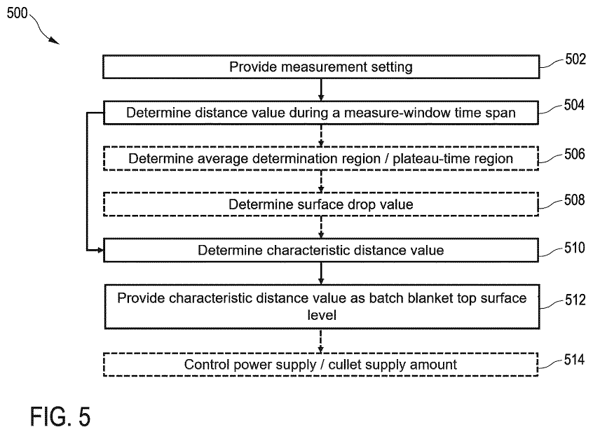

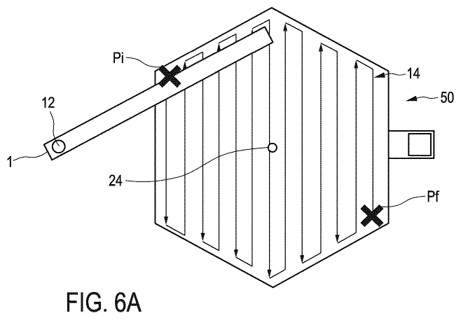

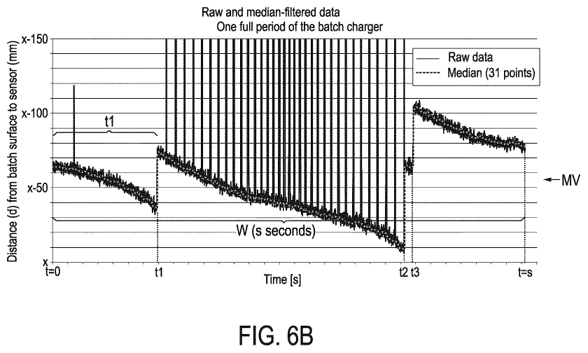

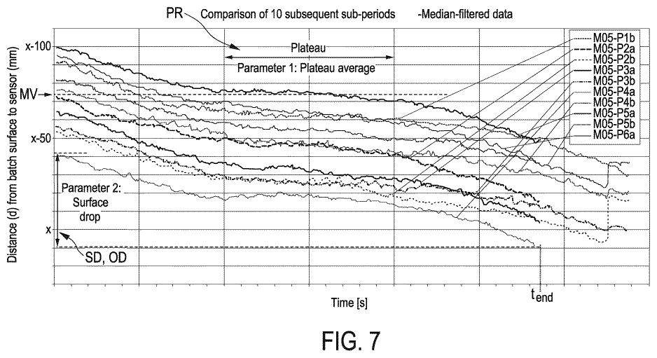

FIG. 5 shows a flow diagram of an embodiment of a method 500 for determining a batch blanket top surface level 2.1 at a cold top electric glass furnace. The method comprises, in a step 502, providing a measurement setting having a measuring position in relation to a surface of measurement, wherein the measuring position is preferably assigned to a predetermined reference point of the cold top electric glass furnace (for example, the predetermined reference point can be chosen as a predetermined position of the crown 7) and the surface of measurement is assigned to batch blanket top surface situated in the cold top electric glass furnace on a glass melt, wherein the batch blanket top surface level is subject to level variations. The method further comprises, in a step 504, determining, during a predetermined measure-window time span, distance values indicative of a distance between the measuring position and the batch blanket top surface. The method further comprises, in a step 510, determining a characteristic distance value indicative of a central tendency, for example a mean value, a median value or a mode value, of the distance values d determined during the measure-window time span. Also, the method comprises, in a step 512, providing the characteristic distance value as a batch blanket top surface level. Optionally, as indicated by the dashed lines and arrows, the method 500 can further comprise determining, in a step 506, an average determination region for determining the characteristic distance value. The average determination region can be a fraction of the batch load cycle, or can include only those time points in which a significant distance value has been determined, in order to avoid the use of outliers for the determination of the characteristic value. In a particular non limiting and exemplary development, the average determination region is a plateau-time region in which the determined distance values form a graph with a gradient below a predetermined threshold value and wherein the determination of the characteristic distance value is performed using the distance values within the plateau-time region and/or determining, in a step 508, a surface drop value indicative of a maximum increase of the batch blanket top surface level within a batch-load cycle. This will be explained with respect to FIG. 6 and FIG. 7 in the following.

FIG. 6A shows the representation of the cold top electric glass furnace 50 of FIG. 3A with the position of the measurement orifice 24 or through hole for performing the contactless determination of the distance value d. The reader is referred to the discussion of FIG. 3A and FIG. 4, where an explanation of the technical features referred to in the following is presented.

FIG. 6B shows a time diagram including distance values determined at a predetermined sampling frequency during a measure-window time span W of some seconds, which is essentially the duration of one batch load cycle. This is FIG. 6B shows data for one full period of a batch charger wherein the data are shown as raw data RAW and median filtered data MED. The x-axis is labelled as distance from the batch surface to the sensor in mm, i.e., the distance between the measuring position 20 at which contactless distance-determination unit 16 is arranged and the reflection point 21 at the batch blanket 2 where the transmission radiation TR is reflected as reflected radiation RR.

Shown are the distance values in mm with respect to a reference value x, labelled as raw data RAW and median filtered data MED and the moving median thereof obtained using 31 values of the raw data RAW, in order to reduce or avoid the influence of outliers, e.g. data points that differ significantly from other observation, and which, in this case is due to the batch feeding device 1 travelling across the line of sight of the distance-determination unit 16.

For explanation; the batch load cycle starts at t=0. The distance value determined by the contactless distance determination unit at that point is around x−65 mm, with an increasing trend that accelerates with increasing time. This is predominantly caused by a thinning of the batch blanket layer thickness with increasing time, due to the melting of the batch material at that particular sampling point by the heat of the melted glass below it. The batch feeding device 1 follows the trajectory 14 shown in FIGS. 3A and 6A, starting at initial point Pi. During the time it takes until the trajectory reaches the point below the measurement orifice 24 (time span t1), the feeding of batch material and the movement of the batch feeding device 1 have no significant influence on the raw data or the median value determined.

Approximately at t1, the batch feeding device reaches the point below the measurement orifice 24 and deposits batch material at the reflection point, which causes a sudden decrease on the determined distance value. The determined distance changes from approximately x−35 mm to approximately x−75 mm.

This parameter is referred to as “added batch thickness” and is preferably calculated as an average or mean value over a predetermined time range, such as 50 seconds, of the median value. From that point onwards, the median value of 31 points starts to increase again. The raw data, however, exhibit large peaks. These are the result of the batch feeding device 1 passing below the measurement orifice 24. Since at these precise moments, the transmitted radiation is reflected by the batch feeding device 1, which moves between the batch blanket and the crown, the determined distance is much lower, and is in no way indicative of the distance between the measuring position and the reflection point. The moving median of 31 points helps to significantly reduce the negative influence of these outliers. The number 31 is in this case arbitrary and not limiting at all. Other numbers can be also selected to calculate the median. This value is referred to a floating measurement window. The batch feeding device 1 reaches the final position Pf and then returns, following the same trajectory in the opposite direction, deposits again batch material at t2 and continues its movement towards the initial position Pi, thereby finishing the batch load cycle. From t2 till the end of the batch load cycle, i.e. t=s, the batch feeding device 1 remains at a position where it does not travel below the measurement orifice 24. At approximately t2 the determined distance changes from approximately x−10 mm to approximately x−65 mm.

As it can be seen in the graph shown in FIG. 6B, there is another sudden decrease of the determined distance at approximately t3. This increase is caused by a mass movement of the batch material at a neighbouring position, which moves towards the reflection point, thus changing the determined distance. The characteristic distance value MV can then be calculated using the moving median value of 31 points obtained during the measure-window time span W, which in the example shown in FIG. 6B corresponds to the batch load cycle for one full period of a batch charger wherein the data are shown as raw data RAW and median filtered data MED.

FIG. 7 shows a time diagram showing a comparison of the median-filtered data MED of ten subsequent subperiods. A subperiod is defined as the time between two consecutive batch depositions at a given point, in particular below the measurement orifice 24. Median values of the median-filtered data MED are shown in order to avoid the outliers caused by the movement of the batch feeding device 1, which otherwise would have appear in half of the ten consecutive subperiods.

As it can be seen from the different graphs, independently of the actual median distance values, the graphs show a very similar and reproducible behaviour. First there is a first time region where the distance increases, followed by a plateau-time region where the determined distance value remain substantially constant or fall with a gradient below a predetermined threshold value such as, for example, less than 10 mm/1000 s or 0.01 mm/s. After this plateau-time region, a final time region appears, where the distance increases substantially again, i.e. the gradient is again above the predetermined threshold value. This behaviour is based on the mechanics of floating and on the dynamic relation between the melted glass and the batch blanket, in particular in terms of heat transfer at the interface between them. The determination of the characteristic distance value MV is performed using the distance values obtained during the sub-period, by determining a central tendency of the distance values or of the median distance values (e.g. 31 point moving median, as shown in FIG. 6B). Alternatively, the determination of the characteristic distance value is performed using the distance values or the median distance values obtained within the plateau-time region PR. For example, for the case of plot M05-P5a, the characteristic distance value MV obtained using data determined during the plateau-time region PR is indicated in FIG. 7.

Another parameter that can be extracted from the time graph of the determined distance values is the surface drop SD, defined as the difference in distance between the beginning and the end of each subperiod, and indicative of an overall decrease OD of the batch blanket top surface level. Indicated in FIG. 7 is the surface drop value SD associated to the sub-period (M05-P4a) with the highest distance. The shortest distance value at the beginning of the sub-period is approximately x−40mm. The highest distance value is determined at the end of the sub-period (t=t_{end}), and it is approximately x+10. Thus, the surface drop value of that particular sub-period is (x+10)−(x−40)=50 mm. This value depends on the glass pull, which increases the distance globally because the amount of melted glass inside the main heating chamber is reduced, and also depends on the melting rate of the batch blanket, which reduces its thickness and therefore increases the determined distance, as shown in the diagrams of FIG. 6B and FIG. 7.

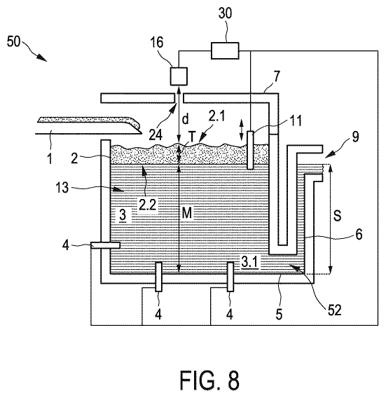

FIG. 8 shows a schematic simplified cross sectional view of a cold top electric glass furnace 50 in accordance with the present disclosure. The cold top electric glass furnace 50 comprises a melting tank 3 comprising a plurality of heating units 4 for heating a glass melt 13. The cold top electric glass furnace 50 also comprises a batch feeding device 1 or batch charger, configured to provide batch material at predetermined different positions of the melting tank 3. The cold top electric glass furnace 50 further comprises a syphon-shaped output 52 comprising a throat section 5 at a lower section 3.1 of the melting tank 3 and, and a riser section 6 connected to the throat section 5 and extending upwards from the throat section 5 to a glass melt output 9. The cold top electric glass furnace 50 also comprises a crown 7 arranged and configured to cover the melting tank 3, also referred to as the main heating chamber. The crown comprises one measurement orifice 24 at a measuring position. The cold top electric glass furnace 50, further comprises a contactless distance-determination 16 unit arranged at the measuring position, as explained above with reference to FIG. 4, and configured to provide a transmission radiation to the batch blanket top surface, to receive reflected radiation reflected by the batch blanket top surface, and to determine a distance amount d between the measuring position and a reflection point at the batch blanket top surface, also as discussed with reference to FIG. 4 above. The cold top electric glass furnace 50 also comprises a control unit 30 connected to the contactless distance-determination unit 16 and configured to control the contactless distance determination unit for determining a batch blanket top surface level as explained with reference to FIG. 5 above.

In other examples of cold top electric glass furnaces, the crown comprises a plurality of measurement orifices and a plurality of contactless distance-determination units, thus providing the measurement setting having a plurality of measuring positions in relation to the surface of measurement. In these particular cold top electric glass furnaces, the control unit is configured to control the plurality of contactless distance determination units for determining respective distance values indicative of a respective distance between the respective measuring position and the batch blanket top surface during a predetermined measure-window time span, determining a respective characteristic distance value indicative of a central tendency of the respective distance values determined during the measure-window time span, and providing the respective characteristic distance value as a mapping of the batch blanket top surface level.

For example, the contactless distance-determination unit 16 can comprise an optical unit, in particular a laser unit, for providing electromagnetic radiation as the transmission radiation. In this case, the distance value is determined using laser distance meter technology for distance measurement; the principles thereof as such for determining a distance by means of wavelength and phase shift and/or time of flight is basically known by a skilled person. Alternatively, or additionally, the contactless distance-determination unit 16 comprises an acoustic unit, in particular an ultrasound unit, for providing acoustic radiation, in particular ultrasonic radiation, as the transmission radiation; also here the principles thereof as such for determining a distance by means of wavelength and phase shift and/or time of flight is basically known by a skilled person.

The cold top electric glass furnace 50 is advantageously configured to determine a batch blanket thickness amount. The control unit 30 is further configured to ascertain a glass-batch blanket interface value M indicative of a position of a lower surface 2.2 of the batch blanket 2, and to determine a batch blanket thickness amount T using the ascertained glass-batch blanket interface value M and the determined batch blanket top surface level d, since a total distance between the bottom section 3.1 of the main heating chamber 3 and the measuring position (see e.g., 20, FIG. 4) is known.

The cold top electric glass furnace 50 is configured to ascertain the glass-batch blanket interface value M by ascertaining a calibration value, in particular an electrode measurement value. This is done by controlling the position, in particular the vertical position, of an electrode 11, and to monitor changes in electrical parameters associated to a change from the batch blanket 2 to the melted glass 13. Additionally, or alternatively, for ascertaining the glass-batch blanket interface value, the control unit 30 can be configured to determine a working end value S of a glass level at a furnace output 9 of the cold top electric glass furnace 50, which, under normal circumstances, i.e. when the working end value S is not limited by the geometry of the output 9, is substantially proportional to the glass-batch blanket interface value M.

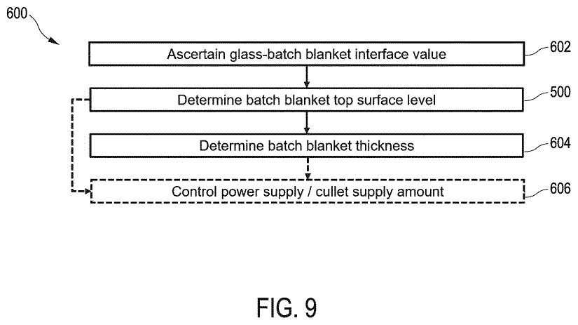

Thus, the cold top electric glass furnace 50 is advantageously configured to carry out a method 600 for determining a batch blanket thickness amount, as shown in FIG. 9.

The method 600 comprises, in a step 602, ascertaining a glass-batch blanket interface value M indicative of a position of a lower surface 2.2 of the batch blanket 2, performing the method 500 of FIG. 5 for determining the batch blanket top surface level, and determining, in a step 604, the batch blanket thickness amount T using the ascertained glass-batch blanket interface value M and the determined batch blanket top surface level d. Since the total distance between the lower portion 3.1 of the melting tank 3 and the measuring position 20 is known and equals d+T+M, the knowledge of d and M enables the determination of the thickness of the batch blanket at the reflection point 21 (see FIGS. 4 and 8).

The method 500 for determining a batch blanket top surface level 2.1 at a cold top electric glass furnace 50 and the method 600 for determining a batch blanket thickness amount T can also be methods for controlling operation of a cold top electric glass furnace if a step 514, 606 of controlling a power supply of the cold top electric glass furnace, i.e. of the heating electrodes 4 and/or a cullet supply amount and/or one or more batch parameters, such as humidity or batch material constituents, in dependence on the batch blanket top surface level d or the thickness of the batch blanket T for maintaining the batch blanket top surface level or the thickness of the batch blanket T within a predetermined operation range.

Indeed, the batch blanket thickness T can be directly or indirectly influenced by the electrical power supplied to the heating electrodes 4. Increasing the power supply of the heating electrodes 4 results in a higher temperature of the glass melt 13, which in turn increases the melting rate of the batch blanket, thereby reducing its thickness. On the other hand, if power supply is reduced, the temperatures decreases and the melting rate decreases as well. If batch material is added at the same rate, the overall thickness of the batch blanket increases.

Also, changes of the proportion of cullet in the batch material have an influence on the batch blanket thickness amount T. Cullet refers to glass pieces added to the batch material which induces a faster melting of the batch blanket thereby reducing the thickness T of the batch blanket 2. Conversely, if the amount of cullet in the batch material is reduced, the melting rate decreases, and the batch blanket thickness amount T increases for a constant batch feeding rate of batch material.

Additionally, changing one or more batch parameters, including the humidity, or the constituents of the batch material, has an effect on the batch blanket thickness amount T.

In summary, the present disclosure is directed to methods for determining a batch blanket top surface level at a cold top electric glass furnace, that comprises providing a measurement setting having a measuring position assigned to a cold top electric glass furnace, in relation to a surface of measurement assigned to batch blanket top surface, determining a distance value indicative of a distance between the measuring position and the batch blanket top surface during a predetermined measure-window time span determining a characteristic distance value indicative of a central tendency of the distance values determined during at least a fraction of the measure-window time span and providing the characteristic distance value as a batch blanket top surface level.

Other variations to the disclosed embodiments can be understood and effected by those skilled in the art in practicing features disclosed herein, from a study of the drawings and the present disclosure.

In the present disclosure, the word “comprising” does not exclude other elements or steps, and the indefinite article “a” or “an” does not exclude a plurality.

A single unit or device can fulfil the functions of several items disclosed in the present disclosure. The mere fact that certain measures are described in mutually different embodiments does not indicate that a combination of these measures cannot be used to advantage.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for determining a batch blanket top surface level at a cold top electric glass furnace, the method comprising:
providing a measurement setting having a measuring position in relation to a surface of measurement, wherein the measuring position is assigned to a predetermined reference point of the cold top electric glass furnace and the surface of measurement is assigned to a batch blanket top surface situated in the cold top electric glass furnace on a glass melt, wherein the batch blanket top surface level is subject to level variations;
determining, during a predetermined measure-window time span, distance values indicative of a distance between the measuring position and the batch blanket top surface;
determining a characteristic distance value indicative of a central tendency of the distance values determined during at least a fraction of the measure-window time span;
providing the characteristic distance value as a batch blanket top surface level.

2. The method of claim 1, wherein the distance values are determined continuously at a predetermined measuring frequency and wherein the respective characteristic distance values are determined and provided using the distance values determined during a floating measurement window.

3. The method of claim 1, wherein the predetermined reference point is a fixed position.

4. The method of claim 1, wherein the characteristic distance value is a statistical value indicative of a mean value, a median value or a mode value of the distance values determined during the at least a fraction of the predetermined measure-window time span.

5. The method of claim 1, comprising determining a surface drop value indicative of an overall decrease of the batch blanket top surface level within a batch load cycle.

6. The method of claim 1, comprising:
providing the measurement setting having a plurality of measuring positions in relation to the surface of measurement;
determining respective distance values indicative of a respective distance between the respective measuring position and the batch blanket top surface during a predetermined measure-window time span;
determining a respective characteristic distance value indicative of a central tendency of the respective distance values determined during the measure-window time span; and
providing the respective characteristic distance value as a mapping of the batch blanket top surface level.

7. A method for determining a batch blanket thickness amount, comprising:
ascertaining a glass-batch blanket interface value indicative of a position of a lower surface of a batch blanket;
performing the method of claim 1 for determining the batch blanket top surface level; and
determining the batch blanket thickness amount using the ascertained glass-batch blanket interface value and the determined batch blanket top surface level.

8. The method of claim 7, wherein ascertaining the glass-batch blanket interface value comprises ascertaining an electrode measurement value.

9. The method of claim 7, wherein ascertaining the glass-batch blanket interface value comprises determining a working end value of a glass level at a glass melt output of the cold top electric glass furnace.

10. A method for controlling operation of a cold top electric glass furnace, the method comprising:
performing the method of claim 1, for determining the batch blanket top surface level; and
controlling a power supply of the cold top electric glass furnace and/or a cullet supply amount and/or one or more batch parameters in dependence on the batch blanket top surface level for maintaining the batch blanket top surface level within a predetermined operation range.

11. The method of claim 10 further comprising:
ascertaining a glass-batch blanket interface value indicative of a position of a lower surface of a batch blanket;
determining the batch blanket thickness amount using the ascertained class-batch blanket interface value and the determined batch blanket top surface level; and
controlling the power supply of the cold top electric glass furnace and/or the cullet supply amount and/or the one or more batch parameters in dependence on the batch blanket thickness amount.

12. The method of claim 10, wherein the power supply and/or the cullet supply amount and/or the one or more batch parameters are controlled so that the determined batch blanket thickness amount is maintained within a predetermined range.

13. A cold top electric glass furnace comprising:
a heating chamber comprising a heating unit for heating a glass melt;
a batch feeder configured to provide batch material at predetermined different positions of the heating chamber;
a syphon-shaped output comprising a throat section at a lower section of the heating chamber, and a riser section connected to the throat section and extending upwards from the throat section to a glass melt output;
a crown arranged and configured to cover the heating chamber, where at least one measuring position is configured to be alternatively associated with at least one spot below the crown in general fixed position enabling a view of the batch blanket;
a measurement setting having a measuring position in relation to a surface of measurement, wherein the measuring position is assigned to a predetermined reference point of the cold top electric glass furnace and the surface of measurement is assigned to a batch blanket top surface situated in the cold top electric glass furnace on a glass melt, wherein a batch blanket top surface level is subject to level variations;
a contactless distance-determination unit arranged at the measuring position and configured to provide a transmission radiation to the batch blanket top surface, to receive reflected radiation reflected by the batch blanket top surface, and to determine a distance amount between the measuring position and a reflection point at the batch blanket top surface; and
a controller connected to the contactless distance-determination unit, wherein the measurement setting and the contactless distance-determination unit are configured to perform the method for determining a batch blanket top surface level of claim 1.

14. The cold top electric glass furnace of claim 13, wherein the contactless distance-determination unit comprises a laser and/or radar unit, configured to provide electromagnetic radiation as the transmission radiation.

15. The cold top electric glass furnace of claim 13, wherein the contactless distance-determination unit comprises an ultrasound unit, configured to provide ultrasonic radiation as the transmission radiation.

16. A non-transitory computer-readable medium having processor-executable instructions stored thereon, wherein the processor-executable instructions, when executed by one or more processors, facilitate performance of the method of claim 1.

17. The method of claim 3, wherein the predetermined reference point is at a crown of the glass furnace.

18. The method of claim 12, wherein the predetermined range is between 20 cm and 30 cm.
